(19) United States
(12) Patent Application Publication
(10) Pub. No.: US 2018/0052437 A1
(43) Pub. Date: Feb. 22, 2018

(54) METHOD AND APPARATUS FOR SENSOR AND/OR ACTUATOR DATA PROCESSING ON A SERVER

(71) Applicant: Ciambella Ltd., Tortola (VG)

(72) Inventors: Jean-Baptiste Leonelli, Levallois (FR); Trisala Chandaria, New York, NY (US)

(21) Appl. No.: 15/683,078

(22) Filed: Aug. 22, 2017

Related U.S. Application Data
(60) Provisional application No. 62/377,968, filed on Aug. 22, 2016.

(51) Int. Cl. G05B 19/05; G06F 3/0482; H04W 4/00; H04W 84/18; H04L 29/08

(52) U.S. Cl. CPC G05B 19/05; G06F 3/0482; H04L 67/025; H04W 84/18; H04W 4/005

(57) ABSTRACT

A method and apparatus for processing data from at least one of a sensor or an actuator on a server is provided. The method comprises receiving, on a server, raw data from at least one of a sensor or an actuator, and processing the raw data on the server according to a predefined algorithm, wherein the server is remote to the at least of the sensor or the actuator. The processed data may be stored on the server, and may be forwarded to a service on a local network, or a service on the Internet for further processing.

### CROSS-REFERENCE TO RELATED APPLICATIONS

The present application claims the benefit of U.S. Provisional Application Ser. No. 62/377,968 filed on Aug. 22, 2016, which is herein incorporated by reference in its entirety.

### BACKGROUND OF THE INVENTION

### Field of the Invention

Embodiments of the present invention generally relate to a method and apparatus for sensor and/or actuator data processing on a server.

### Description of the Related Art

The use of field programmable gate arrays (FPGAs) and other controller devices (e.g. microcontroller or microprocessor based), such as MCU, SoC, mobile phones, computers, etc. have grown considerably popular. Low manufacturing costs, availability, and customization of controllers have led to a proliferation of microcontrollers and Systems on a Chip (SoC) (e.g., PIC, ARDUINO, RASPBERRY PI and the like) being used by commercial companies and hobbyists alike for creation of devices. Controller devices include a processor core and a memory, which are programmable for processing input/output data in communication with peripherals. Program memory in the form of NOR FLASH or OTP ROM is also often included on such controller devices, as well as a small amount of random access memory (RAM).

Real world applications of such controller devices include connecting controller devices with conventional objects or systems as peripherals, such as sensors or actuators, thereby enabling digitization, connectivity and even remote control of such peripherals. Sensors first generate unprocessed or raw data, which is then processed for a meaningful interpretation, for example for a user. Similarly, user instructions must be converted to a format that corresponds to commands that the actuator can implement. This conversion is done by a controller connected to or a part of the sensors and/or actuators. However, the sensors and/or actuators or controller devices connected to such sensors and/or actuators are limited in processing power, storage, connectivity, or a combination thereof, which constrains the speed at which data captured by the sensors and/or actuators can be processed. Due to the controller devices being engaged in processing raw data from sensors and/or actuators, their availability to capture sensor and/or actuator data is low, which, in turn limits the throughput of raw data available from the sensors and/or actuators. Further, continuous processing of raw data increases power consumption by the controller devices. Accordingly, conventional deployment of sensors and/or actuators suffers from several disadvantages.

As the “Internet of Things (loT)” grows, more and more controller devices with sensors and/or actuators interconnect with one another and/or to the Internet. Groups of such devices may communicate with one another and/or to a gateway such that the gateway becomes a proxy for the Internet communications for such group of devices, also called “edge devices”. The edge devices may communicate through one or more gateways, or directly as independent devices. The combined complexity of such systems may further introduce delays in addition to delays due the speed constraints as discussed above. Further, any updates required in the sensors and/or actuators would require updating each sensor individually, which may be excessively time consuming or otherwise difficult to implement. Therefore, conventional deployment of sensors and/or actuators in current technology scenarios limits the utilization of the current technology and the sensors and/or actuators.

Thus, there is a need in the art for techniques that significantly improve the constrained performance of controller devices coupled to, or a part of sensors and/or actuators.

### SUMMARY OF THE INVENTION

Embodiments of the present invention generally relate to a method and apparatus for sensor and/or actuator data processing on a server, substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of an apparatus for sensor and/or actuator data processing on a server, in accordance with an embodiment of the invention;

FIG. 2 is a block diagram of an apparatus for sensor and/or actuator data processing on a server, in accordance with an embodiment of the invention;

FIG. 3 is a block diagram of a graphical user interface (GUI) for sensor and/or actuator data processing, in accordance with an embodiment of the invention;

FIG. 4 is a flow diagram of a method for sensor and/or actuator data processing by a server, in accordance with an embodiment of the invention; and

FIGS. 5-7 illustrate GUI screens for visualization of processed data, the data processed from raw data from a sensor or an actuator, according to an embodiment.

### DETAILED DESCRIPTION

Embodiments of the present invention relate to method and apparatus for sensor and/or actuator data conversion on a server, and more specifically to a method for processing unprocessed sensor and/or actuator data for comprehension of a user. Other embodiments provide a method for processing user specified parameters for implementation on the actuator.

Sensors and/or actuators or controller devices coupled thereto (collectively referred to as sensors and/or actuators) have limited processing power, and therefore, unprocessed or raw data generated by the sensors and/or actuators is sent to a server, remote to such sensors and/or actuators, for further processing. The raw data is streamed to the server, where streaming means that the data is sent to the server as soon as it is generated, or the raw data is sent to the server at predefined time intervals. The server converts the raw data into processed data that is comprehensible in the context of a desired use. For example, raw data from a temperature sensor is converted to a quantity in degrees Celsius, Fahrenheit, or Kelvin. Conversely, the server also converts such quantities in terms of raw data or data based on which an actuator can implement an action. For example, an instruction comprising bringing the state of an LED lamp to medium luminosity may comprise converting the state “medium” to specify a particular voltage for an actuator coupled to the LED lamp for controlling the LED lamp.

Such conversions are performed using conversion specifications, which are algorithms for converting raw data via one or more formulae to processed data or vice versa. Apart from conversion specifications, algorithms for other processing purposes, such as data quality check, data filtering, and the like, are also utilized to process raw data, before or after conversion of raw data. Collectively, conversions specifications and other processing algorithms are referred to herein as “algorithms,” which is also used interchangeably with the term “conversion specification,” unless otherwise apparent from the context.

Conversion of raw data may further utilize details of sensors and/or actuators, such as make and model number, constant values for use with formulae for the given sensors, and the like. In some embodiments, the conversion specifications are stored in libraries, which are accessed for processing the raw data. The conversion specifications may also be defined via a user interface (graphical or non-graphical), generally referred to as a UI, or via a file definition, for example, as stored in the libraries. The UI may be accessible to a user via a user device, or directly by connecting to the server. The libraries may be stored on the server or on a remote device communicably coupled to the server. A program, which may also be stored in the libraries for example, is executed on the server to convert the raw data to processed data using the conversions specifications. The processed data is then used for archival, visualization, analysis, presentation, or other known processing, via the server or via another remote system or remote service, including, but not limited to, FACEBOOK, TWILIO, AMAZON WEB SERVICES, and the like.

In this manner, conversion of raw data from sensors and/or actuators is performed at the server, relieving the usually limited processing capabilities of the sensors and/or actuators, thereby reducing the power consumption by sensors and/or actuators. The power consumption savings can be significant in deployment fields that utilize several hundreds or thousands of such sensors and/or actuators coupled to or comprising a controller device. Further, by removing the requirement to process raw data, sensors and/or actuators become free to use the available processing resources to send more data to the server, greatly increasing the throughput of the sensors and/or actuators. For example, if a sensor senses a particular parameter, and requires 1.2 seconds to compute processed data, then the sensor is unavailable for these 1.2 seconds to sense the particular parameter. At the server, data is processed at a significantly faster rate, and at least a 100 times faster than converting the raw data on the sensors and/or actuators. Therefore, if the sensor resources are dedicated to sending the raw data to the server, additional raw sensor data can be sent to the server in the 1.2 seconds. The server, which has significantly powerful computational resources, can process the additional raw sensor data easily, without causing a lag between the received raw data from the sensor and the processed raw data. In this manner, the throughput of raw data from the sensors and/or actuators, and availability of processed data at the server is significantly increased. Further, conversion specifications, e.g. algorithms, conversion formulae, sensor and/or actuator details can be updated on a server (i.e. a single device) vs. updating multiple individual sensors and/or actuators. Furthermore, additional or different formulae may also be used on the sensor and/or actuator data, if needed, enhancing the capabilities and the utility of a given sensor and/or actuator. As such, sensors and/or actuators send raw data, which is processed on the fly on a remote server, to make the data “human readable” for display.

The server could be based in the cloud, or implemented as a fog device on a gateway device, or a separate device on the same premises as the edge and/or gateway devices. The processed data could then be utilized in multiple ways, for example, for performing analytics, for archiving the data, storing in a database, performing data visualization, among several other known utilizations.

Commonly assigned patent application Ser. No. 11/853,137, filed 11 Sep. 2007; Ser. No. 11/853,143, filed 11 Sep. 2007; Ser. No. 12/931,292, filed 28 Jan. 2011 (now U.S. Pat. No. 8,726,285); Ser. No. 14/307,198, filed 17 Jun. 2014; Ser. Nos. 14/307,227; 14/307,208, filed 17 Jun. 2014; Ser. No. 14/593,151, filed 9 Jan. 2015; Ser. No. 14/685,064, filed 13 Apr. 2015; Ser. No. 15/063,764, filed Mar. 8, 2016; and Ser. No. 15/148,353, filed May 6, 2016, each of which is incorporated herein by reference in their entireties, describe techniques for developing software for a controller device incorporating a controller, mapping the use of hardware such as sensors or actuators to the controller remotely using a graphical user interface, and executing the software, e.g. remotely, to extend the capabilities of such a controller device via defined workflows. These techniques function by placing a snippet of code and/or a library in the memory of the controller device. When the snippet is executed, a call is sent by the controller device for executing a process on a code virtualization server, and/or the controller device sends data (directly or via the code virtualization server) to a service provider, and/or further calls a function to be remotely performed on the data by the service provider. Embodiments of the present invention use these techniques to creating and manage controller based remote solutions comprising at least one controller device coupled to a conventional remote system. With such embodiments remote solutions can be created for dynamic environments, for example conventional systems coupled to controller devices. Further, the embodiments enable changing the code, the inputs for the code, changing the outputs required, configuring additional hardware devices (e.g. sensors, actuators, and the like) for use with the controller devices, or changing the configuration of the solutions, among others. These features can be enabled by a user, using a user computer remote to the code virtualization server, and/or a coding server (on which the code is created and may be executed in part), the controller devices, and the conventional systems.

The controller device comprises at least one controller to execute tasks. The controller is communicably coupled with a memory (for storing code) and with peripheral electronics, e.g., elements of a conventional system or communication electronics coupled to the elements of a conventional system. Some embodiments of the controller device include programmable sub-systems such as ARDUINO, TEXAS INSTRUMENTS LAUNCHPAD, FREESCALE BOARDS KINETIS, ST MICROELECTRONICS STM32, INTEL EDISON, and the like. The controller device may also be a System on a Chip (SoC) such as a RASPBERRY PI and the like. Some embodiments of controller devices include programmed controllers of other assembled devices and systems such as NEST THERMOSTAT, PHILIPPS HUE, BELKIN, WITHINGS, and the like. Sensors and/or actuators include digital or analog sensors and/or actuators, coupled to converters (Analog to Digital, Digital to Analog), temperature sensors, pressure sensors, proximity sensors, connectivity sensors, water sensors, power actuators, physical actuators, and various sensors and/or actuators known in the art.

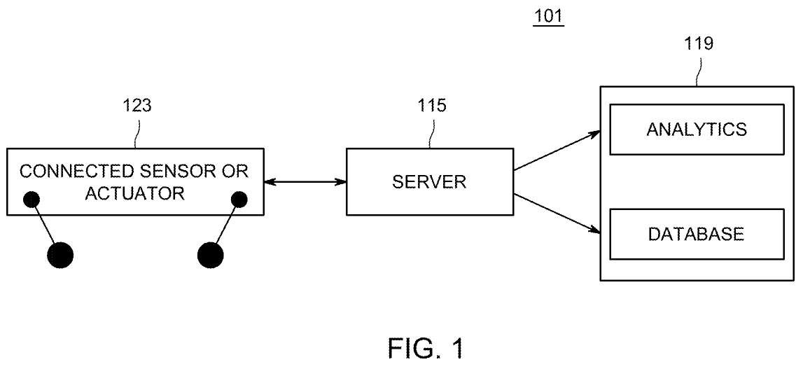

FIG. 1 is a block diagram of an apparatus 101 for sensor and/or actuator data conversion on a server 115, in accordance with an embodiment of the invention. The apparatus 101 comprises a sensor or an actuator 123 communicably coupled to the server 115. The server 115 is also coupled to a remote service 119. According to several embodiments, the sensor or the actuator 123, the server 115 and the remote service 119 are communicably coupled via a communications network, such as a private network, or a public network, such as the Internet, using known techniques. In some embodiments, the sensor or the actuator 123 is communicably coupled to the server 115 via direct wired or wireless communication channels.

According to some embodiments, the sensor or the actuator 123 additionally comprises a controller device for storing or sending unprocessed sensor and/or actuator data to the server, and communication means, such as a wireless transceiver 121 or communication cables (not shown), for communicating with the server 115. The sensor or the actuator 123 sends unprocessed data (or “raw data”) to the server 115 for further processing.

The server 115 receives the raw data from the sensor or the actuator 123, and using conversions specifications available to the server 115, processes the raw data, for example, to a tangible or comprehensible quantity. For example, the raw data may comprise voltage reading from the sensor or the actuator 123, which the server 115 converts to a processed temperature data in degree Celsius based on a conversion specification comprising a conversion formula.

The server 115 further communicates the processed data to systems for performing analytics, storage systems, database systems, and visual interfaces. Such systems may be deployed on the server 115, or on a remote device or via the remote service 119.

In this manner, the server 115 performs the resource intensive conversion of raw data received from the sensor or the actuator 123. Consequently, the sensor or the actuator 123 is relieved from the resource intensive conversion of raw data to processed data, speeding up the availability of processed data at the server 115, and further, potentially reducing the power consumption of the sensor or the actuator 123 due to reduced resource requirements.

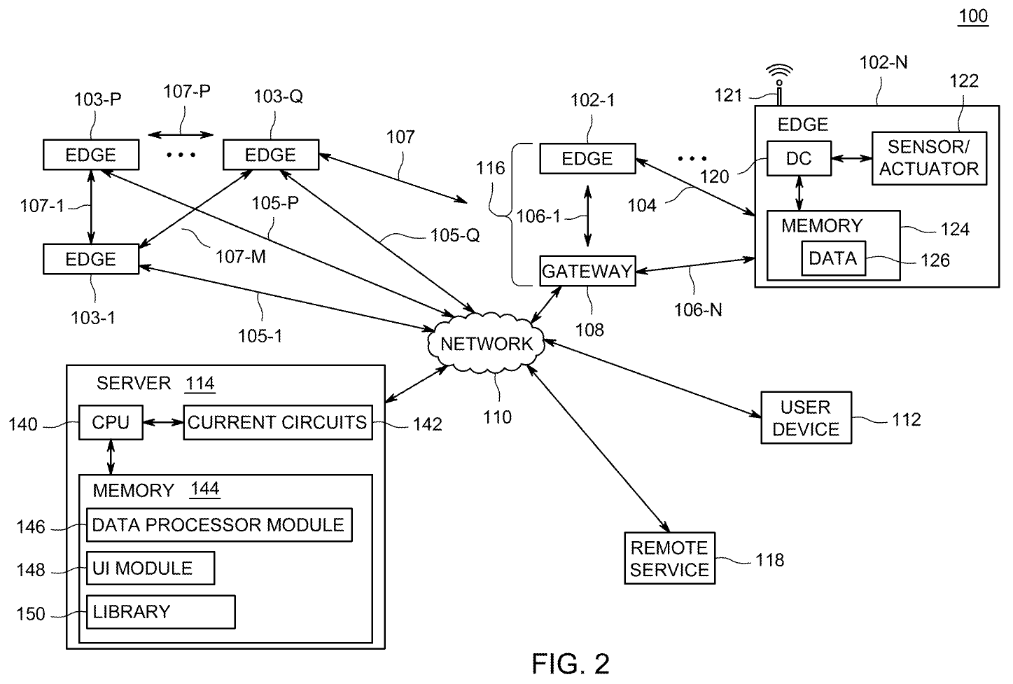

FIG. 2 is an overview diagram of an apparatus 100 for sensor and/or actuator data conversion, in accordance with one or more embodiments of the present invention. The apparatus 100 comprises multiple controller devices comprising edge devices 102-1, 102-2, . . . 102-N (collectively referred to as edge devices 102), multiple controller devices comprising edge devices 103-1, . . . 103-P (collectively referred to as edge devices 103), a controller device comprising a gateway 108, a network 110, a user device 112 or a user computer 112, a server 114, and a remote service 118. In the following discussion, the edge devices 102, 103 and the gateway 108, each comprise a sensor or actuator similar to the sensor and/or actuator 123 of FIG. 1, and each is collectively referred to as a controller device.

The edge devices 102 and the gateway 108 form a group of devices (or device group 116) connected to the network 110. In the device group 116, the gateway 108 communicates internally with edge devices 102 along communications paths 106-1 . . . 106-N, and externally with the network 110. Although the communications paths are generally wireless paths, in some embodiments, the paths may be wired. In addition, in some embodiments, the edge devices 102 communicate among themselves along paths 104 (only one path shown, but may include multiple paths corresponding to a mesh communication network connecting one or more other edge devices 102). Although a single gateway 108 is depicted, multiple gateways may be used within the group 116, or spanning multiple groups similar to the device group 116.

The edge devices 103 communicate directly with the network 110, for example, along paths 105-1 . . . 105-Q. Further, in some embodiments, each edge device 103 can communicate with another edge device 103, for example through paths 107-1, 107-P . . . 107-Q (only few paths shown, but may include multiple paths corresponding to a mesh communication network connecting one or more other edge devices 103). Each edge device 102, each edge device 103, and the gateway 108 is a controller device (or incorporates one), that is coupled to or comprised in a sensor or actuator. For simplicity of discussion, the controller devices are depicted to comprise a device controller and a sensor and/or an actuator.

Each device (edge devices 102, 103, and the gateway 108), is illustrated by the non-limiting example of the device 102-N, includes a device controller (DC) 120, a sensor and/or actuator 122, and a memory 124. The sensor and/or actuator 122 is similar to the sensor and/or actuator 123 of FIG. 1. While only the device 102-N is depicted to comprise these elements for the sake of brevity, each device (edge devices 102, 103 and the gateway 108) includes these components. The device controller 120 may be a microcontroller (e.g., PIC, AVR type, ARM type, and the like) or a SoC (e.g., RASPBERRY PI), or a microprocessor as generally known in the art. The type of controller may differ from device to device, for example, based on the application of such device and the functionality required. The sensors and/or actuators 122 include, but are not limited to, digital or analog sensors, digital or analog actuators, converters (digital to analog, analog to digital), and the like. The memory 124 may be any form of digital storage used for storing data 126 and executable software (not shown). Such memory includes, but is not limited to, random access memory, read only memory, disk storage, optical storage, and the like. The memory 124 stores computer readable instructions corresponding to an operating system (not shown), and sensor and/or actuator data 126 generated by or for consumption of the sensor and/or actuator 122.

The user device 112 is general-purpose computer, such as a personal computer, a laptop, a server class machine, a smartphone, a tablet, and the like as generally known in the art, or other electronic processing device that is programmed to be a specific purpose computer to perform functions related to embodiments of the present invention. The user device 112 comprises a CPU, support circuits and a memory. The CPU may be any commercially available processor, microprocessor, microcontroller, and the like. The support circuits comprise well-known circuits that provide functionality to the CPU such as a user interface, clock circuits, network communications, cache, power supplies, I/O circuits, and the like. In some embodiments, the user interface comprises a keypad, electronic buttons, speaker, touchscreen, display, or other user interaction mechanism. The memory may be any form of digital storage used for storing data and executable software. Such memory includes, but is not limited to, random access memory, read only memory, disk storage, optical storage, and the like. The memory stores computer readable instructions corresponding to an operating system and a graphical user interface (GUI) resident on the user device 112, or accessed from another device, for example, the remote server 114. According to some embodiments, the user device 112 is communicably coupled to the network 110 when defining algorithms, including conversion specifications via the GUI, the UI or while specifying a file definition, for conversion of raw data. Accessing the GUI via the user device 112 is a convenient way for a user to specify algorithms, although in some embodiments, the user may directly interface with the server 114 for providing algorithms for processing raw data.

The server 114 may be a general-purpose computer, such as a personal computer, a laptop, a server class machine, a smartphone, a tablet, and the like as generally known in the art, or other electronic processing device that is programmed to be a specific purpose computer to perform functions related to embodiments of the present invention. The server 114 comprises a CPU 140, support circuits 142, and memory 144 containing instructions and algorithms. The CPU 140 processes inputs and outputs to/from the devices. The CPU 140 may be any commercially available processor, microprocessor, microcontroller, and the like. The support circuits 142 comprise well-known circuits that provide functionality to the CPU such as a user interface, clock circuits, network communications, cache, power supplies, I/O circuits, and the like. Alternative embodiments may use control algorithms on a custom Application Specific Integrated Circuit (ASIC). In some embodiments, the user interface comprises a keypad, electronic buttons, speaker, touchscreen, display, or other user interaction mechanism. The memory 144 may be any form of digital storage used for storing data and executable software. Such memory includes, but is not limited to, random access memory, read only memory, disk storage, optical storage, and the like. The memory 144 stores computer readable instructions corresponding to an operating system (not shown), a data processor module 146, a user interface (UI) module 148, and a library 150.

The data processor module 146 converts raw data, that is, unprocessed data received from a sensor or actuator, for example, the sensor and/or actuator 122, to intelligible or usable data, as described in this application. For example, voltage readings of a sensor may be converted to a temperature value in degrees Celsius. Such conversion of unprocessed data or raw data is referred to as processing of raw data, and the temperature value is referred to as processed data. The processing of raw data may comprise refinements or processing of raw data other than the conversion of raw sensor data value to a temperature value and include, testing the quality of raw data, and rejecting or further processing data that does not meet predefined quality standards. In this example, the data processor module 146 utilizes algorithms, for example, as specified by a user using a user interface (graphical or otherwise), or via a file definition, to process the raw data. The algorithms for processing the raw data include algorithms for the other refinements and processing discussed above, in addition to conversion specifications. For example, other algorithms include cleaning raw data, performing data quality checks, data cleaning, among various other operations that may be performed on raw data.

The UI module 148 generates a user interface (UI), which may be a graphical user interface (GUI) or a non-graphical user interface, for allowing a user to provide conversion specifications, specify a location of a file definition comprising conversion specifications, or uploading the file definition. In some embodiments, the UI module 148 renders such a user interface to an input/output device coupled to the server 114. In other embodiments, the UI module 148 renders the user interface via a remote device (e.g. a user device) communicably coupled to the server 114 via the network 110.

The libraries 150 comprise sensor or actuator details. In one embodiment, these libraries 150 comprise details for supplementing conversion specifications. For example, the conversion specifications may include conversion formulas, which may require constant reference values dependent on a particular make of the sensor and/or actuator, and the libraries 150 store such values for several sensors and/or actuators. According to some embodiments, the libraries 150 further comprises conversion specifications, including conversion formulae, for example, conversion specifications provided via the UI generated by the UI module 148. According to some embodiments, the libraries 150 comprise connection parameters for connecting sensors, actuators or associated controller devices to the server 114, for example via the network 110, or via direct wired or wireless connectivity modes. According to some embodiments, the libraries 150 further include predefined programs for implementing additional services on the server 114, or for interacting with remote services, for example, the remote service 118. Such programs include scripts, server side applications, third-party application connectors, gateway to remote web services (e.g. FACEBOOK, DROPBOX, AMAZON) and the like.

Therefore, in the apparatus 100, a user may define or provide algorithms, comprising conversion specifications via the user device 112, which displays Uls based on communication with the UI module 148 on the server 114. The algorithms may be stored in the libraries 150. The data processor module 146, utilizing the algorithms, processes the raw data received from any of the controller devices 102, 103 or 108, and generates processed data on the server 114, which may be stored in the memory 144, and for example, in the data processor module 146 or any other location (not shown) on the server 114.

According to some embodiments, the processed data is utilized for analytics, data visualization and presentation, archival or database storage, among several other utilization of data generally known in the art. In some embodiments, the processed data is forwarded to other systems or services remote to the server 114, for example, the remote service 118, which includes for example, and not as a limitation, FACEBOOK, TWILIO, AMAZON WEB SERVICES, among several others.

According to some embodiments, the data processing functionality, as implemented on the server via the data processor module 146 of the server 114, is implemented on a device other than the server 114. For example, the data processing functionality may be implemented on one or more of the edge devices, on the gateway 108 or other gateways, or on one or more device co-located in the premises as the various controller devices. In such examples, the device on which the data processing functionality is implemented comprises a CPU, support circuits and a memory similar to the CPU of the server 114. That is, such a device comprises computational resources that are significantly more powerful than that of controller devices (e.g., 102, 103 or 108), which are usually configured only for data exchange with sensors, or communication of data among controller devices, or with an external communications network.

While the server 114 is usually cloud based, in some embodiments, one or more tasks normally performed by the server 114 may be executed on the gateway 108, or on the edge device (102, 103), also referred to as a “fog” implementation. Fog implementation of one or more such tasks may reduce issues associated with cloud connectivity or latency. Implementation of the one or more tasks for execution by a device controller (e.g. 120) on an edge device (e.g. 102 or 103), although possible, would be rare, and according to several embodiments, such a configuration where one or more tasks are implemented on an edge device, would be excluded.

In some embodiments, one of the edge devices, 103-P is a device comprising a CPU, support circuits and memory that are significantly more powerful (at least a 100×, and in some embodiments between about 200× to about 2000×) than the controller devices 102, 103, 108. The device 103-P is a ‘special’ controller device in the sense that it is computationally significantly more powerful than most of the other controller devices 103. In such embodiments, memory of the device 103-P comprises processor executable instructions corresponding to the data processor module 146. While the reference is made to the edge device 103-P, any of the edge devices 102 may be similarly configured. In some embodiments, the gateway 108 comprises a similarly powerful set of a CPU, support circuits and a memory, which comprises processor executable instructions corresponding to the data processor module 146. In some embodiments, an external device (not shown) on same premises as the controller devices (102, 103, 108) comprises a similarly powerful set of a CPU, support circuits and a memory, which comprises processor executable instructions corresponding to the data processor module 146. Any of these devices may perform the functionality of the server 114 corresponding to processing the raw data to generate processed data, and communicate the processed data to the server 114, for example, via the network 110. In some embodiments, other functionalities displayed on the server 114 may also be deployed on such devices (e.g. an edge device, a gateway or a device on the same premises as the controller devices).

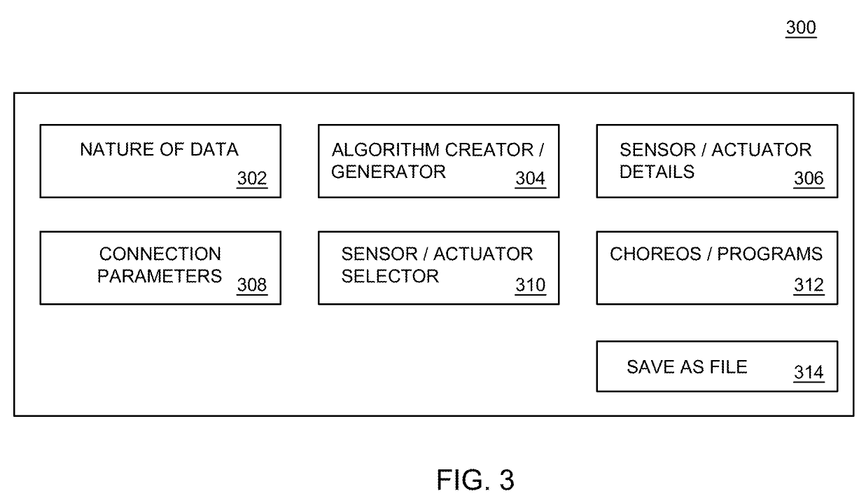

FIG. 3 is a block diagram of a graphical user interface (GUI) 300 for sensor and/or actuator data conversion, in accordance with an embodiment of the invention. The GUI 300 is generated using the UI module 148 of FIG. 2, and may be displayed to a user via the user device 112. The GUI 300 comprises several UI elements 302-314, with which a user interacts to provide inputs. The UI element 302 allows for specifying nature of data that the sensor or actuator will send, for example, a potential difference measured in Volts, a current measured in Amperes, and the like. The UI element 304 allows for specifying or generating algorithms, for example, conversion specifications including conversion formula, or other algorithms for raw data processing as discussed above. The UI element 306 allows for specifying sensor or actuator details, including the make, model and other operational parameters. The sensor or actuator details may also include the type of sensors or actuators, for example, sensors for sensing Temperature, Motion, Gas, GPS, Power, Light, Liquid, Proximity, Touch, among several others. The UI element 308 allows for specifying connection parameters for communicably coupling sensors and/or actuators to the server 114, for example via the network. Connection parameters include, without limitation, WiFi settings, Bluetooth settings, cellular data connectivity settings, LAN settings, or any parameters associated with any other mode of connectivity. The UI element 310 allows for specifying sensors or actuators, for which raw data will be processed on the server. The UI element 312 allows for specifying choreos for accessing remote services or programs to implement other functionalities, such as analytics, data visualization, archiving or storing to a database, and the like. According to some embodiments, one or more of the UI elements 302-312 access the libraries for providing options from which a selection is made for specifying the corresponding input. According to some embodiments, one or more of the UI elements 302-312 allow for specifying a file definition to specify the corresponding input. The file definition may be in the form of a file stored on the server 114, or a remote location communicably coupled via the network 110, and selectable via the UI elements 302-312. The UI element 314 allows for saving any of the inputs received via the UI elements 302-312 as a file on the server 114. The inputs entered via the UI 300 are used for conversion of raw data received from sensors and/or actuators 122 on the server 114.

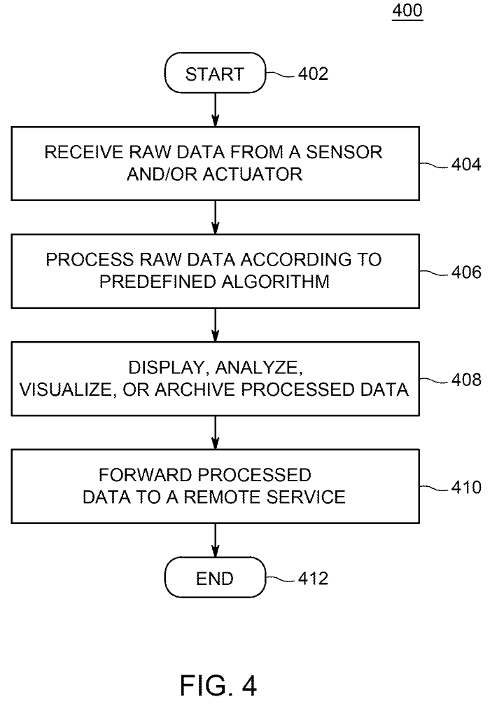

FIG. 4 depicts a flow diagram of a method 400 executed by the server 114 for sensor and/or actuator data conversion, in accordance with embodiments of the present invention. The method 400 begins at step 402 and proceeds to step 404, at which the method 400 receives raw or unprocessed data from a sensor and/or an actuator. As discussed, raw data includes unprocessed signals generated by the sensors and communicated to the server 114.

At step 406, the method 400 processes the raw data according to predefined algorithms, which may include conversion specifications. Algorithms include one or more conversion formulas, to convert raw sensor and/or actuator data into tangible data. For example, for a specific temperature sensor for measuring temperature in degrees Celsius, the temperature sensor provides a raw data output as an electrical potential difference, in Volts. For an analog temperature sensor TMP36GT9Z manufactured by ANALOG DEVICES INC., generating the corresponding temperature in degrees Celsius, the conversion formulae specific to this sensor are defined as:

Volts=(x/(<board-adc-resolution>−1))*(<board-max-adc-voltage>) [Formula 1]

where
x=sensor raw reading or raw data for the sensor
board-adc-resolution=resolution of the Analog to Digital Converter (ADC) implemented on the controller device to which the sensor is attached to.
board-max-adc-voltage=maximum voltage rating of the controller device, without compromising the ADC

Temperature in Celsius=(Volts*100)−50 [Formula 2]

Several similar formulas are defined for different sensors and form a part of the algorithms or conversion specifications. As discussed above, such conversion specifications are defined using a UI, for example UI 300, or by specifying a file definition. Utilizing the significantly higher processing power of the server to convert raw sensor and/or actuator data to processed data allows for a higher throughput of the sensor and/or actuator in generating and communicating data to the server. The processed data may then be further utilized, for example, according steps 408 or 410.

At step 408, the method 400 utilizes the processed data generated at step 406, to display the data, for example as a table, analyze the data using various analysis techniques generally known in the art, visualize the processed data using known techniques, or archive the processed data, for example using a database. At step 410, the method 400 forwards the processed data to a remote service, for example the remote service 118, such as FACEBOOK, TWILIO, AMAZON WEB SERVICE, among several others. The method 400 proceeds to step 412, at which the method 400 ends.

In other embodiments (not shown), the steps 408 or 410 are implemented when the processed data matches a certain condition. For example, in the example of temperature sensor, when the temperature is between 30 degrees Celsius and 50 degrees Celsius, the step 408 is implemented. Similarly, when the temperature is above 50 degrees Celsius, the step 410 is implemented.

In this manner, the server 114 or a device with comparatively significantly higher processing power is utilized to convert raw data to processed data for further processing, relieving the sensors and/or actuators and allowing for generating higher number of data points and communicating raw data to the server, resulting in a higher throughput from the sensors and/or actuators. Further, processed data or conditions similar to processed data may be converted in a similar manner to parameters that are directly input to the actuators. For example, if a medium light setting for an actuator connected to a LED lamp corresponds to a voltage of 0.7 Volts, the server 114 sends a signal of 0.7 Volts to the actuator instead of sending an actuator setting of ‘medium’. In this manner, the server 114 sends ‘raw’ data to the actuators, obviating the need for the actuator to first convert ‘medium’ to 0.7 Volts, and then actuating the LED lamp accordingly, thereby relieving the actuator of processing effort. The relieving of sensors and/or actuators in the manner above reduces power consumption of the sensors and/or actuators, which translate to significant savings in systems with a large number (e.g. hundreds or thousands) of such sensors and/or actuators. Processing raw data on the server 114 is computationally faster, and further, conversion formulae may be updated via the server by changing conversion specifications, without requiring and update of each of the sensors or actuators individually, greatly enhancing the capability of the sensors and/or actuators. Furthermore, other algorithms may be updated to apply advanced data processing techniques (data quality check, data cleaning, etc.) to raw sensor data without requiring an update of sensors or actuators.

The inventors have observed significant efficiency gains in for conversion of raw data on the server. The exact efficiency gain depends on the relationship between the conversion equation, the controller device embedded in or coupled to the sensor and/or actuator, and the processor on the server. For example, calculating a linear equation on Arduino Yun controller as compared to a cloud server, for example, an EC2 (Amazon Elastic Compute Cloud) server depends on the difference between processor clock speeds on the Arduino Yun controller and the EC2 server. In this example, the Arduino Yun controller has a clock speed of 16 MHz, while a standard EC2 instance has a clock speed of 3.3 GHz, making the conversion on the EC2 server 206 times faster. As conversions become more complex, while the efficiencies are reduced, they remain significant. The inventors have observed 10× efficiencies when dealing with complex non-linear conversions. Further, the inventors have run conversion comparison tests on an Arduino Yun controller and an EC2 server instance, which involved running several sensor conversions several (1023) different values, and repeating this process 10 times, and then taking an average, which is presented in TABLE 1 below.

TABLE 1

| | | Cloud Server | |
|---|---|---|---|
| | Arduino Yun | (e.g. EC2) | Server |
| Sensor (Make/Model and Types) | (16 MHz) | (2.4 GHz) | Advantage |
| LMT84LP (TI temp sensor) | 1242956 μs | 3558 μs | 349x |
| TMP36GT9Z (Analog Devices | 350460 μs | 1605 μs | 218x |
| temp sensor) | | | |
| GP2Y0A21YK0F (Sharp | 3404548 μs | 3019 μs | 1128x |
| proximity sensor) | | | |
| M3051-000005-100PG (Pressure | 654732 μs | 1952 μs | 335x |
| sensor, TE Connectivity | | | |
| Measurement Specialties) | | | |
| Generic 4-20mA formula | 499996 μs | 1251 μs | 399x |

As can be seen, the comparison results range from a 218×-1128× increase in conversion speed when handling conversions on the server (EC2 2.4 GHz) as opposed to on the controller device (Arduino Yun 16 MHz).

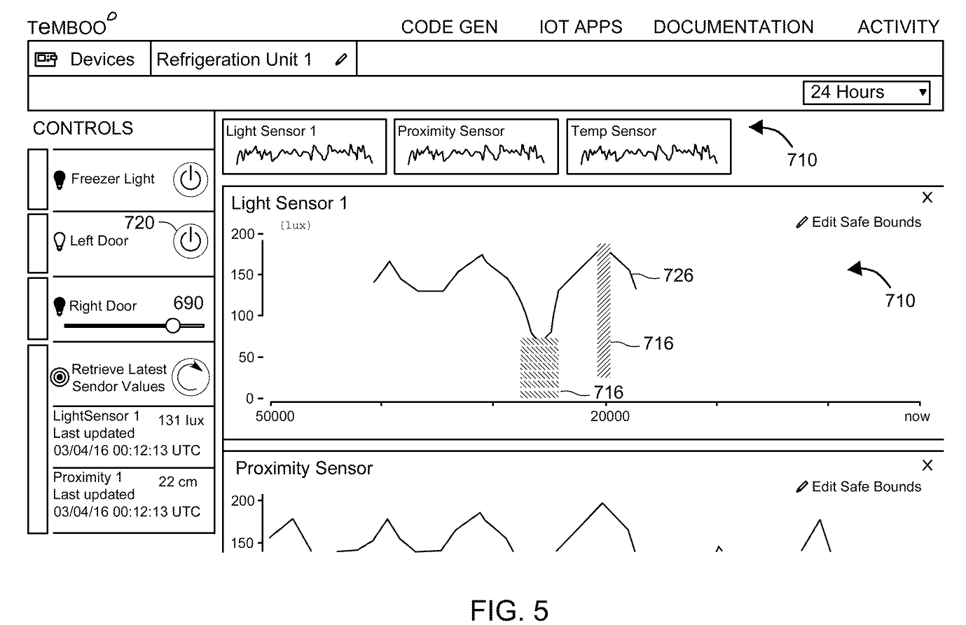

As an example, the GUIs of FIGS. 5-7 illustrate use of sensor and/or actuator data processed on the fly on a remote server, and displayed to a user, for example, for monitoring and controlling systems associated with sensors and/or actuators.

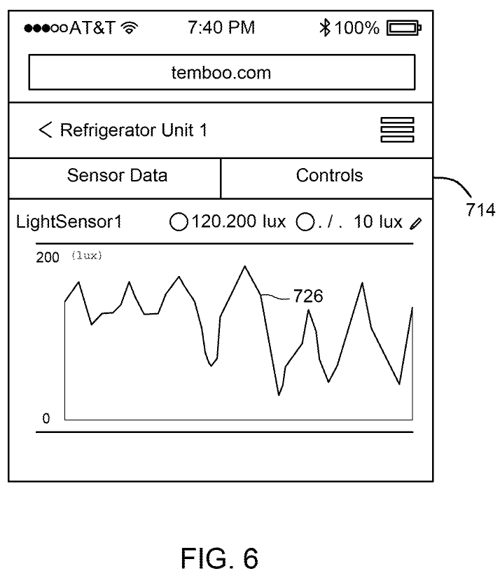

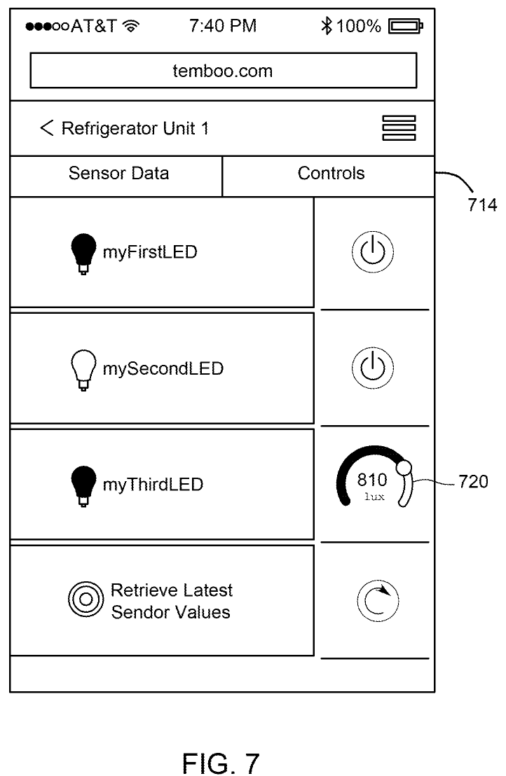

For example, FIG. 5 illustrates a GUI screen for visualization of processed data. The GUI screen comprises multiple graphs 710 generated using processed data, according to an embodiment. Raw sensor or actuator data is processed on a server according to a predefined algorithm, the server remote to corresponding sensor or actuator. For example, the graphs 710 show visual data for light sensor, proximity sensor and a temperature sensor. The graph 726 further shows visualization of monitored data for a light sensor (Light Sensor 1 corresponding to a left door of a refrigeration unit) in detail, along with units for luminous emittance, i.e. lux, that are intelligible to a viewer or user. Although not shown in FIG. 5, similar units may also be included in the graphs 710, for example, degrees Fahrenheit for the temperature sensor graph, and inches or feet for the proximity sensor graph. FIGS. 6 and 7 illustrate visualization of the raw sensor or actuator data, processed by a server remote to the sensor or actuator, and displayed in a human readable form, according to an embodiment. A user may comprehend the processed data and may manipulate controls 714 to modify the environment of the sensor or actuator to a desired state. For example, in FIG. 6, the user views the raw data from the LightSensor1 processed by a server remote to the LightSensor1, and selects the option 714 to modify the controls. In FIG. 7, the user selects one of the light sources, e.g. “myThirdLED” to set the desired value to 810 lux. The value of 810 lux is then processed by the server to a format that the actuator (remote to the server) can receive as an input and correspondingly set the light source at the luminous emittance of 810 lux.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method for processing data from at least one of a sensor or an actuator on a server, comprising:
receiving, on a server, raw data from at least one of a sensor or an actuator; and
processing the raw data on the server according to a predefined algorithm, wherein the server is remote to the at least of the sensor or the actuator.

2. The method of claim 1, wherein the server is located on at least one of premises comprising the at least one of the sensor or the actuator, in the cloud, in the fog, or on a gateway coupled to the at least one of the sensor or the actuator.

3. The method of claim 1, wherein the processed data is archived, displayed, or communicated for consumption by a user.

4. The method of claim 1 further comprising conducting on the processed data, at least one of analytics, database storage, or presentation via a visual interface.

5. The method of claim 1 further comprising receiving the algorithm at the server, wherein the algorithm is defined via a graphical user interface (GUI) on a user device remote to the at least one of the sensor or the actuator and the server, or wherein the algorithm is defined via a file definition.

6. The method of claim 1 further comprising defining, at a user device, connection parameters for communicably coupling the at least one of the sensor or the actuator to the server, the connections are defined via at least one of a graphical user interface (GUI) or a file definition, wherein the user device is remote to the server.

7. The method of claim 1, further comprising converting the raw data according to a pre-defined conversion formula comprised in the algorithm, wherein the pre-defined conversion formula is defined using at least one of a graphical user interface (GUI) or a file definition.

8. The method of claim 1 further comprising:
storing the processed data on the server;
forwarding the stored data to a service on a local network, or a service on the Internet.

9. The method of claim 1, wherein the algorithm comprises at least one of conversion algorithms including conversion formulae, data quality check algorithms, or data cleaning algorithms.

10. A system for processing data from at least one of a sensor or an actuator on a server, comprising:
at least one of a sensor or an actuator;
a server coupled to the at least one sensor or the actuator, the server comprising at least one processor and a memory comprising executable instructions, which when executed using the at least one processor implements a method comprising:
receiving, on the server, raw data from the at least one of a sensor or an actuator, and
processing the raw data on the server according to a predefined algorithm, wherein the server is remote to the at least one of the sensor or the actuator; and
a user device for defining the algorithm via a graphical user interface (GUI) on the user device, the user device remote to the at least one of the sensor or the actuator and the server.

11. An apparatus for processing data from at least one of a sensor or an actuator on a server, comprising:
a server comprising at least one processor and a memory comprising executable instructions, which when executed using the at least one processor implements a method comprising:
receiving, on the server, raw data from at least one of a sensor or an actuator; and
processing the raw data on the server according to a predefined algorithm, wherein the server is remote to the at least one of the sensor or the actuator.

12. The apparatus of claim 11, wherein the server is located on at least one of premises comprising the at least one of the sensor or the actuator, in the cloud, in the fog, or on a gateway coupled to the at least one of the sensor or the actuator.

13. The apparatus of claim 11, wherein the processed data is archived, displayed, or communicated for consumption by a user.

14. The apparatus of claim 11, wherein the method further comprises conducting on the processed data, at least one of analytics, database storage, or presentation via a visual interface.

15. The apparatus of claim 11, wherein the algorithm is defined via a graphical user interface (GUI) on a user device remote to the at least one of the sensor or the actuator and the server, or wherein the algorithm is defined via a file definition.

16. The apparatus of claim 11, wherein connection parameters for connecting the at least one of the sensor or the actuator to the server are defined, at a user device, using at least one of a graphical user interface (GUI) or a file definition, wherein the user device is remote to the server.

17. The apparatus of claim 11, wherein the nature of data received from the at least one of the sensor or the actuator, at the server, is specified using at least one of a graphical user interface (GUI) or a file definition.

18. The apparatus of claim 11, wherein the method further comprises converting the raw data according to a pre-defined conversion formula comprised in the algorithm, wherein the pre-defined conversion formula is defined using at least one of a graphical user interface (GUI) or a file definition.

19. The apparatus of claim 11, wherein the method further comprises:
storing the processed data on the server;
forwarding the stored data to a service on a local network, or a service on the Internet.

20. The apparatus of claim 11, wherein the algorithm comprises at least one of conversion algorithms including conversion formulae, data quality check algorithms, or data cleaning algorithms.
